(19) United States
(12) Patent Application Publication
(10) Pub. No.: US 2022/0057604 A1
(43) Pub. Date: Feb. 24, 2022

(54) IMAGING LENS SYSTEM

(71) Applicant: SAMSUNG ELECTRO-MECHANICS CO., LTD., Suwon-si (KR)

(72) Inventors: Ju Hwa SON, Suwon-si (KR); You Jin JEONG, Suwon-si (KR); In Gun KIM, Suwon-si (KR); Yong Joo JO, Suwon-si (KR); Ju Sung Park, Suwon-si (KR)

(73) Assignee: SAMSUNG ELECTRO-MECHANICS CO., LTD., Suwon-si (KR)

(21) Appl. No.: 17/160,654

(22) Filed: Jan. 28, 2021

(30) Foreign Application Priority Data
Aug. 18, 2020 (KR) 10-2020-0103262

(51) Int. Cl. G02B 13/00; G02B 13/18; G02B 9/64

(52) U.S. Cl. CPC G02B 13/0045; G02B 9/64; G02B 13/18

(57) ABSTRACT

An imaging lens system includes a first lens, a second lens, a third lens, a fourth lens, a fifth lens, a sixth lens, and a seventh lens disposed in order from an object side. In the imaging lens system, TTL/2ImgHT is less than 0.640, where TTL is an axial distance between an object-side surface of the first lens and an imaging plane and 2ImgHT is a diagonal length of the imaging plane.

### CROSS-REFERENCE TO RELATED APPLICATION(S)

This application claims the benefit under 35 USC 119(a) of Korean Patent Application No. 10-2020-0103262 filed on Aug. 18, 2020 in the Korean Intellectual Property Office, the entire disclosure of which is incorporated herein by reference for all purposes.

### BACKGROUND

### 1. Field

The present disclosure relates to an imaging lens system including seven lenses.

### 2. Description of the Background

A small-sized camera may be mounted in a wireless terminal device. For example, small-sized cameras may be mounted on a front surface and a rear surface of a wireless terminal device, respectively. Since small-sized cameras are used for various purposes such as outdoor scenery pictures, indoor portrait pictures, and the like, they are required to have a level of performance comparable to that of ordinary cameras. However, it may be difficult for a small-sized camera to implement high performance because a mounting space of the small-sized camera may be restricted by a size of a wireless terminal device. Accordingly, there is a need for development of an imaging lens system which may improve performance of a small-sized camera without increasing a size of the small-sized camera.

The above information is presented as background information only to assist in an understanding of the present disclosure. No determination has been made, and no assertion is made, as to whether any of the above might be applicable as prior art with regard to the disclosure.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

An aspect of the present disclosure is to provide an imaging lens system, capable of implementing high resolution.

In one general aspect, an imaging lens system includes a first lens, a second lens, a third lens, a fourth lens, a fifth lens, a sixth lens, and a seventh lens disposed in order from an object side. A ratio of an axial distance TTL between an object-side surface of the first lens and an imaging plane to a diagonal length 2ImgHT of the imaging plane (TTL/2ImgHT) is less than 0.640.

The sixth lens may have a convex object-side surface.

The object-side surface of the sixth lens may include a first convex portion, a first concave portion, and a second convex portion formed about an optical axis.

The imaging lens system may satisfy SagS11tp is greater than 0.10 mm, where SagS11tp is an optical-axis direction distance from an optical-axis center of an object-side surface of the sixth lens to a point closest to the imaging plane on the object-side surface of the sixth lens.

The imaging lens system may satisfy 0.43<S11tp/S11ER<0.51, where S11tp is a shortest distance from an optical axis to a point closest to an imaging plane on an object-side surface of the sixth lens, and S11ER is an effective radius of the object-side surface of the sixth lens.

The fourth lens may have negative refractive power.

The third lens may have a convex image-side surface.

The imaging lens system may satisfy S1 ER/S14ER is less than 0.290, where S1ER in an effective radius of the object-side surface of the first lens and S14ER is an effective radius of an image-side surface of the seventh lens.

The imaging lens system may satisfy S10ER/S14ER is less than 0.510, where S10ER is an effective radius of an image-side surface of the fifth lens and S14ER is an effective radius of an image-side surface of the seventh lens.

The imaging lens system may satisfy 0.8<f3/f5<1.2, where f3 is a focal length of the third lens, and f5 is a focal length of the fifth lens.

The fifth lens may have a convex object-side surface.

In another general aspect, an imaging lens system includes a first lens having positive refractive power; a second lens having refractive power; a third lens comprising a convex object-side surface; a fourth lens comprising a concave object-side surface and a concave image-side surface; a fifth lens having positive refractive power; a sixth lens having refractive power; and a seventh lens comprising a convex object-side surface. The first to seventh lenses are disposed in order from an object side, and f/ImgHT<1.12, where f is a focal length of the imaging lens system, and ImgHT is a maximum effective image height of the optical imaging system and is equal to one half of a diagonal length of an effective imaging area of an imaging surface of an imaging plane.

The imaging lens system may satisfy SagS11mx is less than −0.4 mm, where SagS11mx is an optical-axis direction distance from an optical-axis center of an object-side surface of the sixth lens to an end portion of an effective radius of the object-side surface of the sixth lens.

The imaging lens system may satisfy |SagS11tp/SagS11mx| is less than 0.3, where SagS11tp is an optical-axis direction distance from an optical-axis center of the object-side surface of the sixth lens to a point closest to the imaging plane on the object-side surface of the sixth lens.

The fifth lens may have a convex object-side surface or a convex image-side surface.

Other features and aspects will be apparent from the following detailed description, the drawings, and the claims.

### BRIEF DESCRIPTION OF DRAWINGS

FIG. 1 is a view illustrating an imaging lens system according to a first example.

FIG. 2 is a view illustrating aberration curves of the imaging lens system illustrated in FIG. 1.

FIG. 3 is a view illustrating an imaging lens system according to a second example.

FIG. 4 is a view illustrating aberration curves of the imaging lens system illustrated in FIG. 3.

FIG. 5 is a view illustrating an imaging lens system according to a third example.

FIG. 6 is a view illustrating aberration curves of the imaging lens system illustrated in FIG. 5.

FIG. 7 is a partially enlarged view of a sixth lens according to the first to third examples.

FIG. 8 is a view illustrating the imaging lens systems according to the first to third examples provided in a lens barrel.

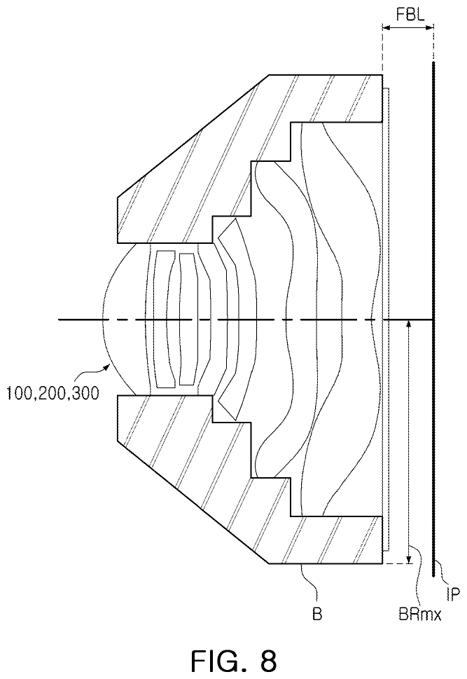

Throughout the drawings and the detailed description, the same reference numerals refer to the same elements. The drawings may not be to scale, and the relative size, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that would be well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will fully convey the scope of the disclosure to one of ordinary skill in the art.

Herein, it is noted that use of the term “may” with respect to an example or embodiment, e.g., as to what an example or embodiment may include or implement, means that at least one example or embodiment exists in which such a feature is included or implemented while all examples and embodiments are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

The drawings may not be to scale, and the relative sizes, proportions, and depiction of elements in the drawings may be exaggerated for clarity, illustration, and convenience.

In the examples, a first lens refers to a lens most adjacent to an object (or a subject), and a seventh lens refers to a lens most adjacent to an imaging plane (or an image sensor). In the examples, units of a radius of curvature, a thickness, a TTL, an IMGHT (half of a diagonal length of an imaging plane), and a focal length are indicated in millimeters (mm). A thickness of a lens, a gap between lenses, and a TTL refer to a distance of a lens in an optical axis. Also, in the descriptions of a shape of a lens, the configuration in which one surface is convex indicates that an optical axis region of the surface is convex, and the configuration in which one surface is concave indicates that an optical axis region of the surface is concave. Thus, even when it is described that one surface of a lens is convex, an edge of the lens may be concave. Similarly, even when it is described that one surface of a lens is concave, an edge of the lens may be convex.

An imaging lens system may include seven lenses. For example, the optical system may include a first lens, a second lens, a third lens, a fourth lens, a fifth lens, a sixth lens, and a seventh lens disposed in order from the object side. The first to seventh lenses may be disposed at predetermined intervals. For example, each lens may not be in contact with an image-side surface and an object-side surface of an adjacent lens in a paraxial portion.

The imaging lens system may be configured to be mounted in a thinned portable terminal device. For example, a ratio of an axial distance TTL between an object-side surface of the first lens and an imaging plane, to a diagonal length 2ImgHT of an imaging plane (TTL/2ImgHT) may be less than 0.64. For example, since the imaging lens system according to the various examples has a significantly small height as compared with a size of the imaging plane (or an image sensor), the imaging lens system may be mounted in an ultra-thin portable terminal and may perform high-resolution image capturing and photography.

In the description below, lenses and other components constituting the imaging lens system will be described.

The first lens may have refractive power. For example, the first lens may have positive refractive power. One surface of the first lens may be convex. For example, the first lens may have a convex object-side surface. The first lens may have an aspherical surface. For example, both surfaces of the first lens may be aspherical. The first lens may be manufactured using a material having high light transmissivity and excellent workability. For example, the first lens may be manufactured using a plastic material. The first lens may have a low refractive index. For example, the refractive index of the first lens may be less than 1.6.

The second lens may have refractive power. The second lens may have an aspherical surface. For example, both sides of the second lens may be aspherical. The second lens may be manufactured using a material having high light transmissivity and excellent workability. For example, the second lens may be manufactured using a plastic material. The second lens may have a higher refractive index than the first lens. For example, the refractive index of the second lens may be 1.6 or more. As another example, the refractive index of the second lens may be 1.67 or higher.

The third lens may have refractive power. At least one surface of the third lens may be convex. For example, the third lens may have a convex object-side surface. The third lens may have an aspherical surface. For example, both surfaces of the third lens may be aspherical. The third lens may be manufactured using a material having high light transmissivity and excellent workability. For example, the third lens may be manufactured using a plastic material. The third lens may have a refractive index substantially similar to the refractive index of the first lens. For example, the refraction of the third lens may be less than 1.6.

The fourth lens may have refractive power. For example, the fourth lens may have negative refractive power. One surface of the fourth lens may be concave. For example, the fourth lens may have a concave object-side surface. The fourth lens may have an aspherical surface. For example, both surfaces of the fourth lens may be aspherical. The fourth lens may be manufactured using a material having high light transmissivity and excellent workability. For example, the fourth lens may be manufactured using a plastic material. The fourth lens may have a higher refractive index than the first lens. For example, the refractive index of the fourth lens may be 1.6 or more. As another example, the refractive index of the fourth lens may be 1.67 or more.

The fifth lens may have refractive power. For example, the fifth lens may have positive refractive power. One surface of the fifth lens may be convex. For example, the fifth lens may have a convex object-side surface or a convex image-side surface. A shape of the object-side surface of the fifth lens may have a relationship to the image-side surface of the third lens. For example, when the object-side surface of the fifth lens is convex, the image-side surface of the third lens may be concave. When the object-side surface of the fifth lens is concave, the image-side surface of the third lens may be convex. The fifth lens may have an aspherical surface. For example, both surfaces of the fifth lens may be aspherical. The fifth lens may be manufactured using a material having high light transmissivity and excellent workability. For example, the fifth lens may be manufactured using a plastic material. For example, the refractive index of the fifth lens may be 1.6 or more.

The sixth lens may have refractive power. One surface of the sixth lens may be convex. For example, the sixth lens may have a convex object-side surface. The sixth lens may have a shape having an inflection point. For example, an inflection point may be formed on at least one of an object-side surface and an image-side surface of the sixth lens. A first convex portion, a first concave portion, and a second convex portion may be sequentially formed on the object-side surface of the sixth lens about an optical axis. To provide an additional description, the first convex portion may be formed in an optical axis portion or a paraxial portion on the object-side surface of the sixth lens, the second convex portion may be formed in an edge portion on the object-side surface of the sixth lens, and the first concave portion may be formed between the first convex portion and the second convex portion. In addition, the first concave portion may have a point closest to the imaging plane from the object-side surface of the sixth lens. The sixth lens may have an aspherical surface. For example, both surfaces of the sixth lens may be aspherical. The sixth lens may be manufactured using a material having high light transmissivity and excellent workability. For example, the sixth lens may be manufactured using a plastic material. The sixth lens may have a lower refractive index than the other lenses. For example, the refractive index of the sixth lens may be lower than 1.54.

The seventh lens may have refractive power. At least one surface of the seventh lens may be convex. For example, the seventh lens may have a convex object-side surface. The seventh lens may have a shape having an inflection point. For example, one or more inflection points may be formed on at least one of an object-side surface of the seventh lens and the imaging plane. The seventh lens may have an aspherical surface. For example, both surfaces of the seventh lens may be aspherical. The seventh lens may be manufactured using a material having high light transmissivity and excellent workability. For example, the seventh lens may be manufactured using a plastic material. The seventh lens may have a refractive index substantially similar to the refractive index of the first lens. For example, the refractive index of the seventh lens may be less than 1.6.

As described above, each of the first to seventh lenses has an aspherical surface. An aspherical surface of each of the first to seventh lenses may be represented by Equation 1 as below:

(Equation 1)

$$Z = \frac{c {r}^{2}}{1 + \sqrt{1 - ( 1 + k ) {c}^{2} {r}^{2}}} + A {r}^{4} + B {r}^{6} + C {r}^{8} D {r}^{10} + E {r}^{12} + F {r}^{14} + {Gr}^{16} + H {r}^{18} + {Jr}^{20}$$

In equation 1, “c” is an inverse of a radius of a curvature of a respective lens, “k” is a conic constant, “r” is a distance from a certain point on an aspherical surface of the lens to an optical axis, “A to J” are aspheric constants, “Z” (or SAG) is a height from a certain point on an aspherical surface to an apex of the aspherical surface in an optical axis direction.

The imaging lens system further may include a filter, an image sensor, and a stop.

The filter may be disposed between the seventh lens and the image sensor. The filter may block light of certain wavelengths. For example, the filter may block light of infrared wavelengths. The image sensor may form an imaging plane on which light, refracted through the first to seventh lenses, may be reflected. The image sensor converts an optical signal into an electrical signal. For example, the image sensor may convert an optical signal, incident on an imaging plane, into an electrical signal. The stop may be disposed to adjust the intensity of light incident on a lens. For example, the stop may be disposed between the second lens and the third lens.

The imaging lens system may satisfy one or more of the following conditional expressions.

0.10 mm<SagS11tp

0.43<S11tp/S11ER<0.51

S1ER/S14ER<0.29

0.43<S10ER/S14ER<0.51

f/ImgHT<1.12

SagS11mx<−0.40 mm

|SagS11tp/SagS11mx|<0.30

0.8<f3/f5<1.2

0.84 mm≤FBL

f number<2.10

In the above conditional expressions, SagS11tp is a an optical-axis direction distance from an optical-axis center of the object-side surface of the sixth lens to a point closest to the imaging plane on the object-side surface of the sixth lens, S11tp is a shortest distance from the object-side surface of the sixth lens to a point closest to the imaging plane on the object-side surface of the sixth lens, S11 ER is an effective radius of the object-side surface of the sixth lens, S1 ER is an effective radius of the object-side surface of the first lens, S14ER is an effective radius of the image-side surface of the seventh lens, S10ER is an effective radius of the image-side surface of the fifth lens, f is a focal length of the imaging lens system, ImgHT is a maximum effective image height of the optical imaging system and is equal to one half of a diagonal length of the effective imaging area of the imaging surface of the image sensor, SagS11mx is a distance in the optical axis direction from the optical-axis center of the object-side surface of the sixth lens to an end portion of an effective radius of the object-side surface of the sixth lens, f3 is a focal length of the third lens, f5 is a focal length of the fifth lens, and FBL is a distance from a tip (a portion closest to the imaging plane) of a lens barrel, accommodating the first to seventh lenses, to the imaging plane.

For reference, in the values of SagS11tp and SagS11mx, a positive sign means that a corresponding point is disposed closer to the imaging plane than to the optical-axis center of the object-side surface of the sixth lens, and a negative sign means that a corresponding point is disposed closer to the object-side surface of the sixth lens than to the optical-axis center of the object-side surface of the sixth lens.

In the description below, various examples of an imaging lens system will be described.

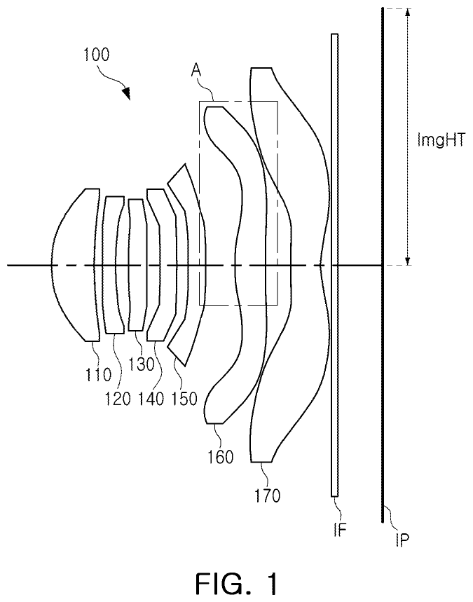

Hereinafter, an imaging lens system 100 according to a first example will be described with reference to FIG. 1.

The imaging lens system 100 may include a first lens 110, a second lens 120, a third lens 130, a fourth lens 140, a fifth lens 150, a sixth lens 160, and a seventh lens 170.

The first lens 110 may have positive refractive power, and may have a convex object-side surface and a concave image-side surface. The second lens 120 may have negative refractive power, and may have a convex object-side surface and a concave image-side surface. The third lens 130 may have positive refractive power, and may have a convex object-side surface and a concave image-side surface. The fourth lens 140 may have negative refractive power, and may have a concave object-side surface and a concave image-side surface. The fifth lens 150 may have positive refractive power, and may have a convex object-side surface and a convex image-side surface. The sixth lens 160 may have positive refractive power, and may have a convex object-side surface and a concave image-side surface. In addition, the sixth lens 160 may have a shape in which inflection points are formed on the object-side surface and the image-side surface. Two inflection points may be formed on the object-side surface of the sixth lens 160. The seventh lens 170 may have negative refractive power, and may have a convex object-side surface and a concave image-side surface. In addition, the seventh lens 170 may have a shape in which inflection points are formed on the object-side surface and the image-side surface.

The imaging lens system 100 may further include a filter IF and an image sensor IP. The filter IF may be disposed between the seventh lens 170 and the image sensor IP. For reference, although not illustrated in the drawings, a stop may be disposed between the second lens 120 and the third lens 130.

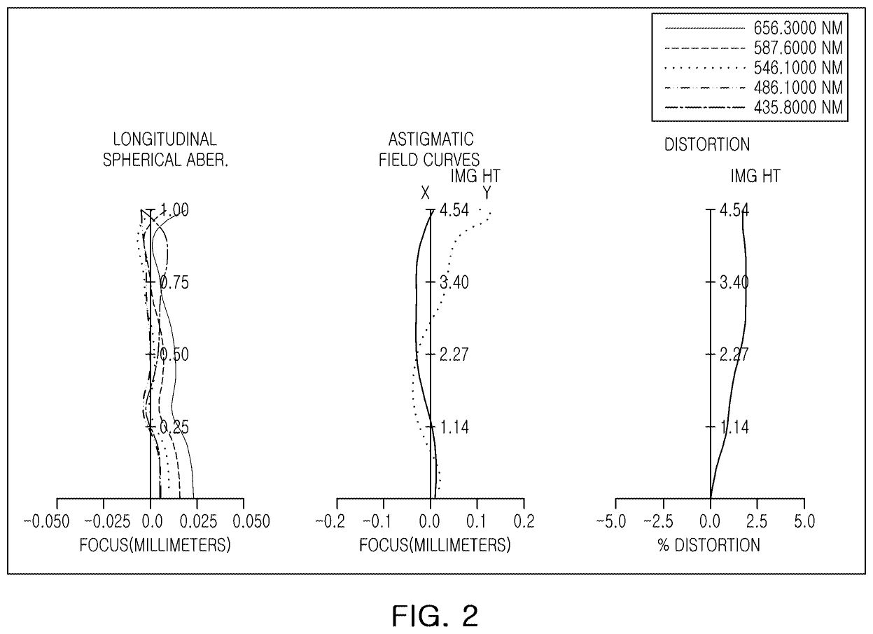

The above-configured imaging lens system 100 exhibits aberration characteristics as illustrated in FIG. 2. Lens characteristics and aspheric values of the imaging lens system 100 according to the first example are listed in Table 1 and Table 2.

TABLE 1

| Sur- | | | Thick- | Effec- | Refrac- | |
|---|---|---|---|---|---|---|
| face | | Radius of | ness/ | tive | tive | Abbe |
| No. | Note | Curvature | Distance | Radius | Index | Number |
| S1 | First Lens | 1.81229 | 0.733798 | 1.3400 | 1.546 | 56.095 |
| S2 | | 7.09554 | 0.133098 | 1.2632 | | |
| S3 | Second | 20.78661 | 0.230000 | 1.2079 | 1.679 | 19.231 |
| | Lens | | | | | |
| | (Stop) | | | | | |
| S4 | | 5.74041 | 0.221725 | 1.0880 | | |
| S5 | Third | 8.47592 | 0.301905 | 1.0880 | 1.546 | 56.095 |
| | Lens | | | | | |
| S6 | | 18.97550 | 0.239732 | 1.1634 | | |
| S7 | Fourth | −25.07115 | 0.280000 | 1.1868 | 1.679 | 19.231 |
| | Lens | | | | | |
| S8 | | 23.46281 | 0.193297 | 1.3436 | | |
| S9 | Fifth Lens | 30.55822 | 0.309767 | 1.4478 | 1.620 | 25.953 |
| S10 | | −65.55973 | 0.501687 | 1.7900 | | |
| S11 | Sixth Lens | 3.51453 | 0.509951 | 2.5683 | 1.537 | 55.710 |
| S12 | | 11.92352 | 0.439464 | 2.8231 | | |
| S13 | Seventh | 3.90443 | 0.510124 | 3.4148 | 1.546 | 56.095 |
| | Lens | | | | | |
| S14 | | 1.47384 | 0.176452 | 3.5834 | | |
| S15 | Filter | infinity | 0.110000 | 4.2260 | 1.519 | 64.197 |
| S16 | | infinity | 0.759795 | 4.2658 | | |
| S17 | Imaging | infinity | −0.010000 | 4.7360 | | |
| | Plane | | | | | |

TABLE 2

| Surface No. | S1 | S2 | S3 | S4 | S5 | S6 | S7 |
|---|---|---|---|---|---|---|---|
| K | −4.933E−01 | −9.962E−01 | −1.000E+00 | 5.669E−03 | 4.964E+00 | −5.461E+00 | −7.677E+01 |
| 4th order | 5.592E−03 | −1.945E−02 | −7.229E−02 | −3.744E−02 | −5.097E−04 | −4.802E−02 | −4.778E−02 |
| 6th order | 7.119E−02 | 1.223E−01 | 6.882E−01 | 4.813E−01 | −6.778E−01 | 8.941E−02 | −1.477E−01 |
| 8th order | −4.274E−01 | −1.300E+00 | −5.131E+00 | −4.846E+00 | 6.655E+00 | 2.443E−01 | 5.939E−01 |
| 10th order | 1.670E+00 | 8.554E+00 | 2.629E+01 | 3.323E+01 | −4.411E+01 | −7.440E+00 | −1.265E+00 |
| 12th order | −4.339E+00 | −3.567E+01 | −9.257E+01 | −1.530E+02 | 2.033E+02 | 4.926E+01 | −1.155E+00 |
| 14th order | 7.764E+00 | 9.979E+01 | 2.306E+02 | 4.903E+02 | −6.695E+02 | −1.834E+02 | 1.565E+01 |
| 16th order | −9.686E+00 | −1.943E+02 | −4.144E+02 | −1.120E+03 | 1.598E+03 | 4.460E+02 | −5.005E+01 |
| 18th order | 8.388E+00 | 2.688E+02 | 5.423E+02 | 1.845E+03 | −2.779E+03 | −7.479E+02 | 9.408E+01 |
| 20th order | −4.913E+00 | −2.659E+02 | −5.165E+02 | −2.197E+03 | 3.515E+03 | 8.831E+02 | −1.179E+02 |
| 22th order | 1.814E+00 | 1.867E+02 | 3.537E+02 | 1.873E+03 | −3.193E+03 | −7.340E+02 | 1.016E+02 |
| 24th order | −3.376E−01 | −9.095E+01 | −1.695E+02 | −1.113E+03 | 2.025E+03 | 4.207E+02 | −5.995E+01 |
| 26th order | −9.594E−03 | 2.920E+01 | 5.386E+01 | 4.382E+02 | −8.506E+02 | −1.583E+02 | 2.322E+01 |
| 28th order | 1.642E−02 | −5.559E+00 | −1.019E+01 | −1.027E+02 | 2.124E+02 | 3.519E+01 | −5.338E+00 |
| 30th order | −2.165E−03 | 4.752E−01 | 8.683E−01 | 1.083E+01 | −2.386E+01 | −3.500E+00 | 5.536E−01 |
| Surface No. | S8 | S9 | S10 | S11 | S12 | S13 | S14 |
| K | 0.000E+00 | −9.244E+00 | 1.000E+01 | −4.207E+01 | −2.101E+01 | −1.637E+01 | −5.991E+00 |
| 4th order | −7.754E−02 | −1.240E−01 | −1.305E−01 | 6.806E−02 | −5.648E−02 | −3.507E−01 | −1.914E−01 |
| 6th order | 3.026E−02 | 7.680E−02 | 6.384E−02 | −1.178E−01 | 1.268E−01 | 3.005E−01 | 1.629E−01 |
| 8th order | −5.258E−02 | −9.204E−02 | −3.097E−02 | 1.240E−01 | −1.752E−01 | −2.056E−01 | −1.100E−01 |
| 10th order | −1.163E−01 | 1.002E−01 | 9.901E−03 | −1.324E−01 | 1.457E−01 | 1.080E−01 | 5.564E−02 |
| 12th order | 1.093E+00 | 2.126E−01 | 3.553E−02 | 1.178E−01 | −8.264E−02 | −4.029E−02 | −2.065E−02 |
| 14th order | −3.864E+00 | −1.280E+00 | −7.642E−02 | −7.823E−02 | 3.387E−02 | 1.065E−02 | 5.627E−03 |
| 16th order | 8.290E+00 | 2.864E+00 | 7.837E−02 | 3.753E−02 | −1.029E−02 | −2.026E−03 | −1.131E−03 |
| 18th order | −1.194E+01 | −3.870E+00 | −4.862E−02 | −1.293E−02 | 2.338E−03 | 2.807E−04 | 1.676E−04 |
| 20th order | 1.198E+01 | 3.479E+00 | 1.829E−02 | 3.186E−03 | −3.959E−04 | −2.841E−05 | −1.817E−05 |
| 22nd order | −8.421E+00 | −2.134E+00 | −3.520E−03 | −5.547E−04 | 4.914E−05 | 2.077E−06 | 1.419E−06 |
| 24th order | 4.082E+00 | 8.852E−01 | −2.677E−05 | 6.648E−05 | −4.328E−06 | −1.068E−07 | −7.734E−08 |
| 26th order | −1.302E+00 | −2.381E−01 | 1.672E−04 | −5.210E−06 | 2.550E−07 | 3.655E−09 | 2.787E−09 |
| 28th order | 2.463E−01 | 3.757E−02 | −3.269E−05 | 2.402E−07 | −8.975E−09 | −7.468E−11 | −5.950E−11 |
| 30th order | −2.095E−02 | −2.647E−03 | 2.139E−06 | −4.935E−09 | 1.420E−10 | 6.867E−13 | 5.690E−13 |

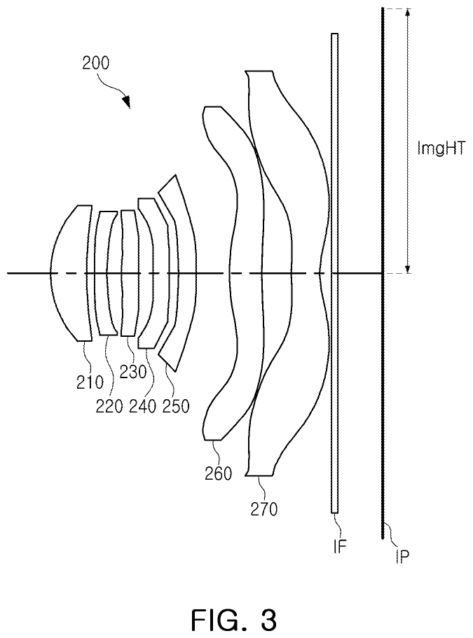

Hereinafter, an imaging lens system according to a second example will be described with reference to FIG. 3.

The imaging lens system 200 may include a first lens 210, a second lens 220, a third lens 230, a fourth lens 240, a fifth lens 250, a sixth lens 260, and a seventh lens 270.

The first lens 210 may have positive refractive power, and may have a convex object-side surface and a concave image-side surface. The second lens 220 may have negative refractive power and may have a convex object-side surface and a concave image-side surface. The third lens 230 may have positive refractive power, and may have a convex object-side surface and a convex image-side surface. The fourth lens 240 may have negative refractive power, and may have a concave object-side surface and a concave image-side surface. The fifth lens 250 may have positive refractive power, and may have a concave object-side surface and a convex image-side surface. The sixth lens 260 may have positive refractive power, and may have a convex object-side surface and a concave image-side surface. In addition, the sixth lens 260 may have a shape in which inflection points are formed on the object-side surface and the image-side surface. Two inflection points may be formed on the object-side surface of the sixth lens 260. The seventh lens 270 may have negative refractive power, and may have a convex object-side surface and a concave image-side surface. In addition, the seventh lens 270 may have a shape in which inflection points are formed on the object-side surface and the image-side surface.

The imaging lens system 200 may further include a filter IF and an image sensor IP. The filter IF may be disposed between the seventh lens 270 and the image sensor IP. For reference, although not illustrated in the drawings, a stop may be disposed between the second lens 220 and the third lens 230.

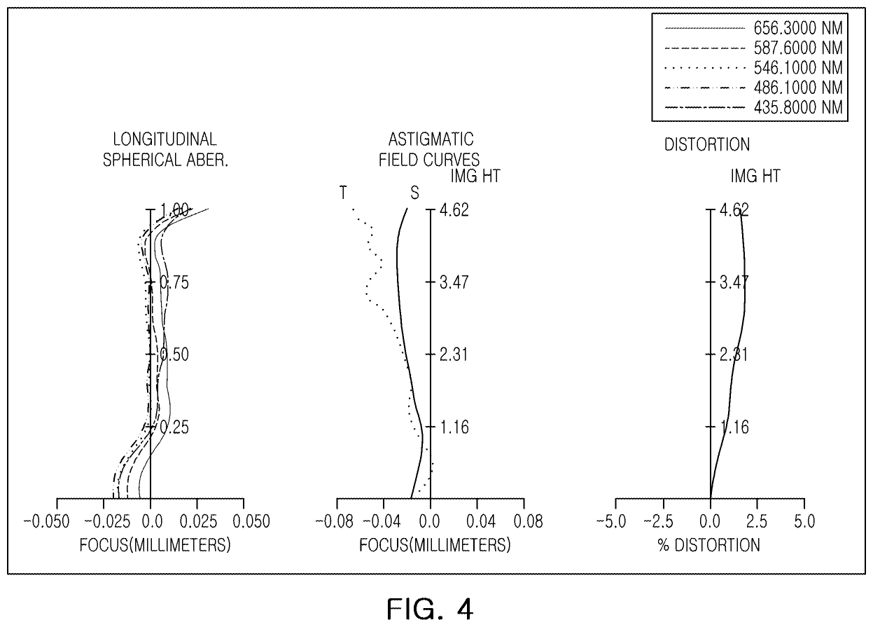

The above-configured imaging lens system 200 exhibits aberration characteristics as illustrated in FIG. 4. Lens characteristics and aspheric values of the imaging lens system 200 according to the second example are listed in Table 3 and Table 4.

TABLE 3

| Sur- | | | Thick- | Effec- | Refrac- | |
|---|---|---|---|---|---|---|
| face | | Radius of | ness/ | tive | tive | Abbe |
| No. | Note | Curvature | Distance | Radius | Index | Number |
| S1 | First Lens | 1.83156 | 0.632211 | 1.2350 | 1.546 | 56.095 |
| S2 | | 7.22763 | 0.132432 | 1.1700 | | |
| S3 | Second | 9.10853 | 0.230000 | 1.1165 | 1.679 | 19.231 |
| | Lens | | | | | |
| | (Stop) | | | | | |
| S4 | | 4.29418 | 0.260405 | 1.0485 | | |
| S5 | Third | 16.33712 | 0.307797 | 1.0500 | 1.546 | 56.095 |
| | Lens | | | | | |
| S6 | | −119.70661 | 0.250430 | 1.1349 | | |
| S7 | Fourth | −11.94853 | 0.280000 | 1.1688 | 1.679 | 19.231 |
| | Lens | | | | | |
| S8 | | 40.19864 | 0.160431 | 1.3600 | | |
| S9 | Fifth Lens | −56.80941 | 0.309047 | 1.4708 | 1.646 | 23.508 |
| S10 | | −12.37536 | 0.599820 | 1.7768 | | |
| S11 | Sixth Lens | 3.40878 | 0.577225 | 2.7320 | 1.537 | 55.710 |
| S12 | | 11.03168 | 0.514475 | 3.0261 | | |
| S13 | Seventh | 4.33111 | 0.510210 | 3.4748 | 1.546 | 56.095 |
| | Lens | | | | | |
| S14 | | 1.54469 | 0.190517 | 3.6774 | | |
| S15 | Filter | infinity | 0.110000 | 4.3015 | 1.519 | 64.197 |
| S16 | | infinity | 0.741910 | 4.3415 | | |
| S17 | Imaging | infinity | 0.016849 | 4.8220 | | |
| | Plane | | | | | |

TABLE 4

| Surface No. | S1 | S2 | S3 | S4 | S5 | S6 | S7 |
|---|---|---|---|---|---|---|---|
| K | −5.520E−01 | 1.000E+00 | 1.000E+00 | 7.709E−01 | 1.829E+01 | −4.132E+01 | 4.134E+01 |
| 4th order | 9.210E−03 | −3.371E−03 | −3.493E−02 | −4.268E−02 | −2.291E−02 | −2.832E−02 | −4.875E−02 |
| 6th order | 5.320E−02 | −1.007E−01 | 1.919E−01 | 6.485E−01 | −2.967E−01 | −1.090E−01 | −1.285E−01 |
| 8th order | −3.851E−01 | 7.686E−01 | −1.010E+00 | −6.910E+00 | 3.493E+00 | 1.000E+00 | 3.115E−01 |
| 10th order | 1.915E+00 | −3.489E+00 | 4.203E+00 | 4.883E+01 | −2.713E+01 | −7.592E+00 | −1.552E−01 |
| 12th order | −6.528E+00 | 1.087E+01 | −1.206E+01 | −2.321E+02 | 1.411E+02 | 3.791E+01 | −4.035E+00 |
| 14th order | 1.576E+01 | −2.438E+01 | 2.396E+01 | 7.709E+02 | −5.108E+02 | −1.282E+02 | 2.237E+01 |
| 16th order | −2.739E+01 | 4.038E+01 | −3.221E+01 | −1.833E+03 | 1.319E+03 | 3.029E+02 | −6.586E+01 |
| 18th order | 3.452E+01 | −4.999E+01 | 2.605E+01 | 3.156E+03 | −2.461E+03 | −5.099E+02 | 1.264E+02 |
| 20th order | −3.154E+01 | 4.621E+01 | −5.060E+00 | −3.940E+03 | 3.323E+03 | 6.152E+02 | −1.672E+02 |
| 22th order | 2.065E+01 | −3.146E+01 | −1.552E+01 | 3.528E+03 | −3.216E+03 | −5.283E+02 | 1.540E+02 |
| 24th order | −9.441E+00 | 1.529E+01 | 2.075E+01 | −2.206E+03 | 2.172E+03 | 3.150E+02 | −9.749E+01 |
| 26th order | 2.861E+00 | −5.005E+00 | −1.287E+01 | 9.144E+02 | −9.715E+02 | −1.240E+02 | 4.048E+01 |
| 28th order | −5.167E−01 | 9.867E−01 | 4.190E+00 | −2.255E+02 | 2.585E+02 | 2.894E+01 | −9.945E+00 |
| 30th order | 4.211E−02 | −8.821E−02 | −5.763E−01 | 2.502E+01 | −3.096E+01 | −3.032E+00 | 1.096E+00 |
| Surface No. | S8 | S9 | S10 | S11 | S12 | S13 | S14 |
| K | 0.000E+00 | −4.712E−01 | −9.834E+00 | −2.887E+01 | −3.375E+01 | −3.813E+01 | −6.263E+00 |
| 4th order | −3.849E−02 | −9.448E−02 | −1.092E−01 | 5.423E−02 | −1.259E−02 | −2.378E−01 | −1.478E−01 |
| 6th order | −2.427E−01 | −2.259E−03 | 1.018E−02 | −8.879E−02 | 3.729E−02 | 1.633E−01 | 1.101E−01 |
| 8th order | 1.460E+00 | 2.743E−01 | 1.705E−01 | 7.438E−02 | −6.501E−02 | −9.593E−02 | −6.889E−02 |
| 10th order | −6.619E+00 | −1.406E+00 | −5.611E−01 | −5.992E−02 | 5.163E−02 | 4.166E−02 | 3.233E−02 |
| 12th order | 2.116E+01 | 4.793E+00 | 1.217E+00 | 4.249E−02 | −2.585E−02 | −1.144E−02 | −1.100E−02 |
| 14th order | −4.828E+01 | −1.109E+01 | −1.807E+00 | −2.321E−02 | 9.329E−03 | 1.795E−03 | 2.724E−03 |
| 16th order | 7.948E+01 | 1.775E+01 | 1.879E+00 | 9.259E−03 | −2.574E−03 | −9.357E−05 | −4.954E−04 |
| 18th order | −9.504E+01 | −2.004E+01 | −1.384E+00 | −2.670E−03 | 5.518E−04 | −2.228E−05 | 6.628E−05 |
| 20th order | 8.250E+01 | 1.610E+01 | 7.239E−01 | 5.541E−04 | −9.088E−05 | 5.872E−06 | −6.482E−06 |
| 22nd order | −5.139E+01 | −9.149E+00 | −2.663E−01 | −8.177E−05 | 1.118E−05 | −6.976E−07 | 4.558E−07 |
| 24th order | 2.237E+01 | 3.595E+00 | 6.730E−02 | 8.351E−06 | −9.849E−07 | 4.999E−08 | −2.234E−08 |
| 26th order | −6.453E+00 | −9.285E−01 | −1.112E−02 | −5.603E−07 | 5.830E−08 | −2.216E−09 | 7.219E−10 |
| 28th order | 1.108E+00 | 1.417E−01 | 1.083E−03 | 2.219E−08 | −2.066E−09 | 5.632E−11 | −1.376E−11 |
| 30th order | −8.570E−02 | −9.676E−03 | −4.714E−05 | −3.927E−10 | 3.302E−11 | −6.304E−13 | 1.167E−13 |

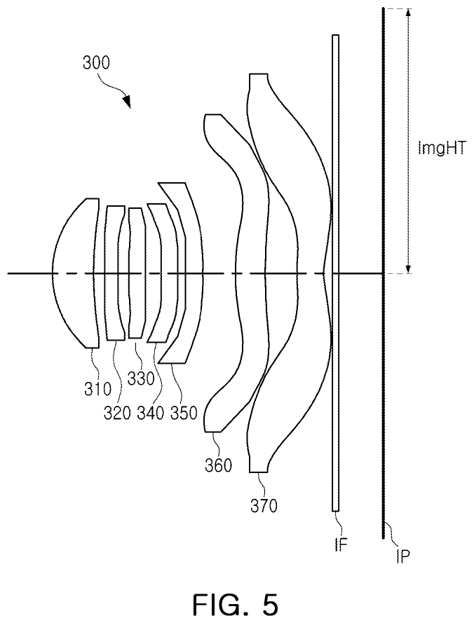

Hereinafter, an imaging lens system according to a third example will be described with reference to FIG. 5.

The imaging lens system 300 may include a first lens 310, a second lens 320, a third lens 330, a fourth lens 340, a fifth lens 350, a sixth lens 360, and a seventh lens 370.

The first lens 310 may have positive refractive power, and may have a convex object-side surface and a concave image-side surface. The second lens 320 may have negative refractive power, and may have a convex object-side surface and a concave image-side surface. The third lens 330 may have positive refractive power, and may have a convex object-side surface and a concave image-side surface. The fourth lens 340 may have negative refractive power, and may have a concave object-side surface and a concave image-side surface. The fifth lens 350 may have positive refractive power, and may have a convex object-side surface and a convex image-side surface. The sixth lens 360 may have positive refractive power, and may have a convex object-side surface and a concave image-side surface. In addition, the sixth lens 360 may have a shape in which inflection points are formed on the object-side surface and the image-side surface. Two inflection points may be formed on the object-side surface of the sixth lens 360. The seventh lens 370 may have negative refractive power, and may have a convex object-side surface and a concave image-side surface. In addition, the seventh lens 370 may have a shape in which inflection points are formed on the object-side surface and the image-side surface.

The imaging lens system 300 may further include a filter IF and an image sensor IP. The filter IF may be disposed between the seventh lens 370 and the image sensor IP. For reference, although not illustrated in the drawings, a stop may be disposed between the second lens 320 and the third lens 330.

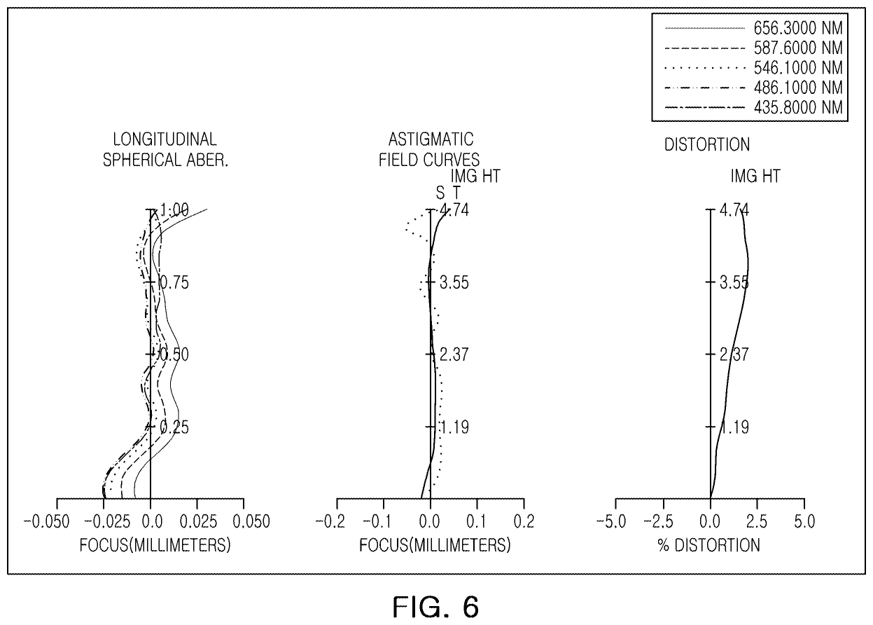

The above-configured imaging lens system 300 exhibits aberration characteristics as illustrated in FIG. 6. Lens characteristics and aspheric values of the imaging lens system 300 according to the second example are listed in Table 5 and Table 6.

TABLE 5

| Sur- | | | Thick- | Effec- | Refrac- | |
|---|---|---|---|---|---|---|
| face | | Radius of | ness/ | tive | tive | Abbe |
| No. | Note | Curvature | Distance | Radius | Index | Number |
| S0 | | infinity | 0 | | | |
| S1 | First Lens | 1.78049 | 0.705030 | 1.3200 | 1.546 | 56.095 |
| S2 | | 5.84195 | 0.186016 | 1.2397 | | |
| S3 | Second | 80.24842 | 0.230000 | 1.1810 | 1.679 | 19.231 |
| | Lens | | | | | |
| | (Stop) | | | | | |
| S4 | | 7.35245 | 0.181235 | 1.0687 | | |
| S5 | Third | 6.43257 | 0.292162 | 1.1000 | 1.546 | 56.095 |
| | Lens | | | | | |
| S6 | | 15.79286 | 0.265942 | 1.1500 | | |
| S7 | Fourth | −11.30545 | 0.270000 | 1.1764 | 1.679 | 19.231 |
| | Lens | | | | | |
| S8 | | 51.78055 | 0.141467 | 1.3400 | | |
| S9 | Fifth Lens | 54.45420 | 0.303262 | 1.4510 | 1.646 | 23.508 |
| S10 | | −22.02894 | 0.549236 | 1.7500 | | |
| S11 | Sixth Lens | 3.02610 | 0.521792 | 2.5693 | 1.537 | 55.710 |
| S12 | | 7.96031 | 0.545579 | 2.8253 | | |
| S13 | Seventh | 4.43185 | 0.450000 | 3.3803 | 1.546 | 56.095 |
| | Lens | | | | | |
| S14 | | 1.49572 | 0.149278 | 3.5138 | | |
| S15 | Filter | infinity | 0.110000 | 4.1683 | 1.519 | 64.197 |
| S16 | | infinity | 0.729838 | 4.2074 | | |
| S17 | Imaging | infinity | 0.019954 | 4.7360 | | |
| | Plane | | | | | |

TABLE 6

| Surface No. | S1 | S2 | S3 | S4 | S5 | S6 | S7 |
|---|---|---|---|---|---|---|---|
| K | −4.968E−01 | 8.725E−02 | −1.000E+00 | 9.635E−01 | −1.516E+01 | 6.320E+01 | 8.226E+00 |
| 4th order | 1.450E−02 | −1.760E−02 | −4.996E−02 | −4.927E−02 | −2.706E−02 | −7.440E−02 | −1.356E−01 |
| 6th order | 3.872E−02 | −3.219E−01 | 5.515E−02 | 1.927E−01 | −1.208E+00 | 5.889E−01 | 9.102E−01 |
| 8th order | 1.844E+00 | 3.023E+00 | 5.145E−02 | −1.452E−01 | 1.905E+01 | −1.303E+01 | −1.672E+01 |
| 10th order | −2.167E+01 | −1.639E+01 | 3.521E+00 | −7.791E+00 | −1.832E+02 | 1.423E+02 | 1.563E+02 |
| 12th order | 1.303E+02 | 5.855E+01 | −3.287E+01 | 8.655E+01 | 1.147E+03 | −9.648E+02 | −9.494E+02 |
| 14th order | −5.065E+02 | −1.431E+02 | 1.535E+02 | −4.807E+02 | −4.896E+03 | 4.373E+03 | 4.002E+03 |
| 16th order | 1.376E+03 | 2.361E+02 | −4.646E+02 | 1.672E+03 | 1.465E+04 | −1.380E+04 | −1.206E+04 |
| 18th order | −2.700E+03 | −2.325E+02 | 9.841E+02 | −3.920E+03 | −3.123E+04 | 3.100E+04 | 2.635E+04 |
| 20th order | 3.852E+03 | 4.645E+01 | −1.497E+03 | 6.382E+03 | 4.765E+04 | −4.985E+04 | −4.172E+04 |
| 22nd order | −3.954E+03 | 2.331E+02 | 1.633E+03 | −7.241E+03 | −5.164E+04 | 5.699E+04 | 4.738E+04 |
| 24th order | 2.839E+03 | −3.748E+02 | −1.248E+03 | 5.624E+03 | 3.878E+04 | −4.523E+04 | −3.758E+04 |
| 26th order | −1.350E+03 | 2.843E+02 | 6.336E+02 | −2.851E+03 | −1.919E+04 | 2.369E+04 | 1.976E+04 |
| 28th order | 3.808E+02 | −1.132E+02 | −1.919E+02 | 8.501E+02 | 5.621E+03 | −7.358E+03 | −6.188E+03 |
| 30th order | −4.819E+01 | 1.897E+01 | 2.619E+01 | −1.130E+02 | −7.387E+02 | 1.027E+03 | 8.734E+02 |
| Surface No. | S8 | S9 | S10 | S11 | S12 | S13 | S14 |
| K | 1.181E+01 | 1.000E+01 | −1.000E+01 | −3.968E+01 | −6.628E+01 | −9.850E+01 | −9.481E+00 |
| 4th order | −2.362E−01 | −6.069E−01 | −1.282E+00 | 3.192E+00 | −4.771E+00 | −4.582E+01 | −2.961E+01 |
| 6th order | 6.799E−01 | 3.511E+00 | 3.988E+00 | −3.424E+01 | 1.201E+02 | 6.039E+02 | 4.050E+02 |
| 8th order | −8.746E+00 | −4.083E+01 | −1.979E+01 | 2.588E+02 | −1.492E+03 | −6.164E+03 | −4.261E+03 |
| 10th order | 3.834E+01 | 3.370E+02 | 9.958E+01 | −2.245E+03 | 1.074E+04 | 4.299E+04 | 3.127E+04 |
| 12th order | 2.684E+01 | −1.887E+03 | −3.720E+02 | 1.569E+04 | −5.151E+04 | −2.031E+05 | −1.623E+05 |
| 14th order | −1.119E+03 | 7.380E+03 | 9.867E+02 | −7.656E+04 | 1.741E+05 | 6.720E+05 | 6.094E+05 |
| 16th order | 6.036E+03 | −2.065E+04 | −1.804E+03 | 2.579E+05 | −4.256E+05 | −1.601E+06 | −1.675E+06 |
| 18th order | −1.817E+04 | 4.187E+04 | 2.183E+03 | −6.057E+05 | 7.620E+05 | 2.786E+06 | 3.382E+06 |
| 20th order | 3.550E+04 | −6.159E+04 | −1.652E+03 | 9.970E+05 | −1.001E+06 | −3.553E+06 | −4.988E+06 |
| 22nd order | −4.685E+04 | 6.503E+04 | 7.047E+02 | −1.143E+06 | 9.556E+05 | 3.287E+06 | 5.292E+06 |
| 24th order | 4.162E+04 | −4.801E+04 | −1.289E+02 | 8.924E+05 | −6.477E+05 | −2.148E+06 | −3.924E+06 |
| 26th order | −2.391E+04 | 2.352E+04 | 0.000E+00 | −4.524E+05 | 2.963E+05 | 9.401E+05 | 1.926E+06 |
| 28th order | 8.037E+03 | −6.867E+03 | 0.000E+00 | 1.342E+05 | −8.230E+04 | −2.474E+05 | −5.619E+05 |
| 30th order | −1.202E+03 | 9.041E+02 | 0.000E+00 | −1.767E+04 | 1.050E+04 | 2.960E+04 | 7.364E+04 |

Characteristic value of the imaging lens systems according to the first to third examples are listed in Table 7.

TABLE 7

| Note | First Example | Second Example | Third Example |
|---|---|---|---|
| f | 5.000000 | 5.100 | 5.000 |
| f1 | 4.2453 | 4.3105 | 4.4154 |
| f2 | −11.7543 | −12.2030 | −11.9378 |
| f3 | 27.7478 | 26.3253 | 19.6428 |
| f4 | −17.8115 | −13.5381 | −13.6451 |
| f5 | 33.6582 | 24.4436 | 24.3345 |
| f6 | 9.0859 | 8.9480 | 8.7656 |
| f7 | −4.6792 | −4.6974 | −4.3677 |
| FOV | 83.23 | 83.00 | 83.20 |
| TTL | 5.640 | 5.824 | 5.650 |
| f number | 1.880 | 2.060 | 1.910 |
| 2ImgHT | 9.072 | 9.240 | 9.480 |

In addition, an imaging lens system according to the present disclosure may generally have optical characteristics, as follows. For example, a total track length TTL of the imaging lens system may be determined within the range of 5.3 mm to 6.0 mm, a total focal length of the imaging lens system may be determined within the range of 4.8 mm to 6.1 mm, a focal length of a first lens may be determined within the range of 3.8 mm to 4.8 mm, a focal length of a second lens may be determined within the range of −16 mm to −10.0 mm, a focal length of a third lens may be determined within the range of 18 mm to 30.0 mm, a focal length of a fourth lens may be determined within the range of −20.0 mm to −11 mm, a focal length of a fifth lens may be determined within the range of 22 mm to 36 mm, a focal length of the sixth lens may be determined within the range of 7.8 mm to 9.8 mm, and a focal length of a seventh lens may be determined within the range of −5.6 mm to −3.8 mm. In addition, a field of view (FOV) of the imaging lens system may be determined within the range of 80.0 degrees to 86 degrees.

Conditional expression values of the imaging lens systems according to the first to third examples are listed in Table 8.

TABLE 8

| Conditional | First | Second | Third |
|---|---|---|---|
| Expression | Example | Example | Example |
| TTL/2ImgHT | 0.6218 | 0.6303 | 0.5961 |
| SagS11tp | 0.1100 | 0.1320 | 0.1320 |
| S11tp/S11ER | 0.4711 | 0.4488 | 0.4970 |
| S1ER/S14ER | 0.2829 | 0.2561 | 0.2787 |
| S10ER/S14ER | 0.4995 | 0.4832 | 0.4980 |
| f/ImgHT | 1.1023 | 1.1039 | 1.0549 |
| SagS11mx | −0.5200 | −0.4540 | −0.5330 |
| \|SagS11tp/SagS11mx\| | 0.2115 | 0.2907 | 0.2477 |
| f3/f5 | 0.8244 | 1.0770 | 0.8072 |
| FBL | 0.8400 | 0.8500 | 0.8500 |

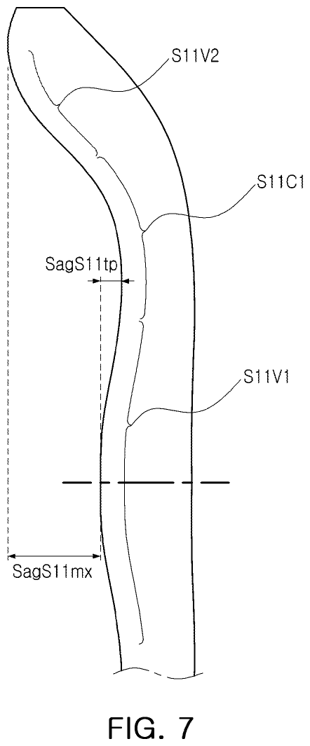

Hereinafter, a detailed shape of the sixth lens will be described with reference to FIG. 7.

The sixth lens (for example, sixth lens 160, sixth lens 260, and sixth lens 360) according to the various embodiments may have both a convex shape and a concave shape on one surface thereof. For example, both the convex shape and the concave shape may be formed on the object-side surface of the sixth lens. A first convex portion S11V1, a first concave portion S11C1, and a second convex portion S11V2 may be sequentially formed from an optical axis along a radius of the sixth lens on the object-side surface of the sixth lens. For example, the first convex portion S11V1 may be formed in a paraxial portion of the sixth lens, the second convex portion S11V2 may be formed in an edge portion of the sixth lens, and the first concave portion S11C1 may be formed between the first convex portion S11V1 and the second convex portion S11V2.

In the first concave portion S11C1, a point S11tp closest to the imaging plane on the object-side surface of the sixth lens may be formed. An optical-axis direction distance SagS11tp from the optical-axis center of the object-side surface of the sixth lens to the point S11tp may be greater than 0.10 mm.

The second convex portion S11V2 may be formed to be more convex than the first convex portion S11V1. For example, the second convex portion S11V2 may be formed to be more convex toward the object-side surface than toward the first convex portion S11V1. A distance SagS11mx from the optical-axis center of the object-side surface of the sixth lens 160 to an end portion of the second convex portion S11V2 (for example, an end portion of the effective radius of the object-side surface of the sixth lens) may be less than −0.4 mm.

Hereinafter, features of a lens barrel, configured to accommodate the imaging lens systems according to the various embodiments, will be described.

A lens barrel B, accommodating the imaging lens systems 100, 200, and 300 according to the first to third examples, is provided. The lens barrel B may be disposed to be significantly close to an imaging plane or an image sensor IP. For example, a distance FBL from a tip of the lens barrel B to the image sensor IP may be greater than 0.84 mm to less than 1.2 mm. The lens barrel B may be formed to have a significant size. For example, an outermost radius BRmx of the lens barrel B may be less than 4.82 mm.

As described above, performance of a small-sized camera may be improved.

While specific examples have been illustrated and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An imaging lens system comprising:
a first lens, a second lens, a third lens, a fourth lens, a fifth lens, a sixth lens, and a seventh lens disposed in order from an object side,
wherein TTL/2ImgHT is less than 0.640, where TTL is an axial distance between an object-side surface of the first lens and an imaging plane and 2ImgHT is a diagonal length of the imaging plane.

2. The imaging lens system of claim 1, wherein the sixth lens comprises a convex object-side surface.

3. The imaging lens system of claim 1, wherein the object-side surface of the sixth lens comprises a first convex portion, a first concave portion, and a second convex portion formed about an optical axis.

4. The imaging lens system of claim 1, wherein SagS11tp is greater than 0.10 mm, where SagS11tp is an optical-axis direction distance from an optical-axis center of an object-side surface of the sixth lens to a point closest to the imaging plane on the object-side surface of the sixth lens.

5. The imaging lens system of claim 1, wherein 0.43<S11tp/S11ER<0.51, where S11tp is a shortest distance from an optical axis to a point closest to an imaging plane on an object-side surface of the sixth lens, and S11ER is an effective radius of the object-side surface of the sixth lens.

6. The imaging lens system of claim 1, wherein the fourth lens has negative refractive power.

7. The imaging lens system of claim 1, wherein the third lens comprises a convex image-side surface.

8. The imaging lens system of claim 1, wherein S1ER/S14ER is less than 0.290, where S1ER in an effective radius of the object-side surface of the first lens and S14ER is an effective radius of an image-side surface of the seventh lens.

9. The imaging lens system of claim 1, wherein S10ER/S14ER is less than 0.510, where S10ER is an effective radius of an image-side surface of the fifth lens and S14ER is an effective radius of an image-side surface of the seventh lens.

10. The imaging lens system of claim 1, wherein 0.8<f3/f5<1.2, where f3 is a focal length of the third lens, and f5 is a focal length of the fifth lens.

11. The imaging lens system of claim 1, wherein the fifth lens comprises a convex object-side surface.

12. An imaging lens system comprising:
a first lens having positive refractive power;
a second lens having refractive power;
a third lens comprising a convex object-side surface;
a fourth lens comprising a concave object-side surface and a concave image-side surface;
a fifth lens having positive refractive power;
a sixth lens having refractive power; and
a seventh lens comprising a convex object-side surface,
wherein the first to seventh lenses are disposed in order from an object side, and
wherein f/ImgHT<1.12, where f is a focal length of the imaging lens system, and ImgHT is a maximum effective image height of the optical imaging system and is equal to one half of a diagonal length of an effective imaging area of an imaging surface of an imaging plane.

13. The imaging lens system of claim 12, wherein SagS11mx is less than −0.4 mm, where SagS11mx is an optical-axis direction distance from an optical-axis center of an object-side surface of the sixth lens to an end portion of an effective radius of the object-side surface of the sixth lens.

14. The imaging lens system of claim 13, wherein |SagS11tp/SagS11mx| is less than 0.3, where SagS11tp is an optical-axis direction distance from an optical-axis center of the object-side surface of the sixth lens to a point closest to the imaging plane on the object-side surface of the sixth lens.

15. The imaging lens system of claim 12, wherein the sixth lens comprises a convex object-side surface.

16. The imaging lens system of claim 12, wherein the fifth lens comprises a convex object-side surface or a convex image-side surface.

17. The imaging lens system of claim 12, wherein 0.8<f3/f5<1.2, where f3 is a focal length of the third lens, and f5 is a focal length of the fifth lens.
